(19) United States
(12) Patent Application Publication
(10) Pub. No.: US 2006/0001533 A1
(43) Pub. Date: Jan. 5, 2006

(54) System and method for monitoring tire pressure

(75) Inventors: Makoto Bessho, Saitama (JP); Goro Komatsu, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/173,352

(22) Filed: Jul. 1, 2005

(30) Foreign Application Priority Data
Jul. 5, 2004 (JP) 2004-198129

(51) Int. Cl. B60C 23/00

(52) U.S. Cl. 340/442; 340/521

(57) ABSTRACT

A system for monitoring a tire pressure includes a sensor unit and a monitoring unit. The sensor unit is mounted on a tire of a vehicle to detect an air pressure in the tire. The monitoring unit is mounted on the vehicle to monitor a signal indicative of the air pressure detected by the sensor unit so as to watch a decrease in the air pressure. The sensor unit includes an accelerometer so as to detect an acceleration acting on the tire. And the monitoring unit classifies the tire as one of a rolling tire and a spare tire based on a signal indicative of the acceleration transmitted by the sensor unit.

### BACKGROUND OF THE INVENTION

The present invention relates to a system and method for monitoring a tire pressure.

A tire pressure monitoring system (hereinafter referred to as “TPMS”), which timely calls a driver's attention to a decrease in a tire pressure of a traveling vehicle, has already been required for a new car as a compulsory system in North America. In addition, there is an indication that this system is becoming widespread in other regions. TPMS are categorized into a direct type (sensor type) which directly detects a tire pressure by an air pressure sensor, and an indirect type which estimates a decrease in a tire pressure based on a difference in a rotational speed of a tire. In the present specification, a TPMS is meant to represent a direct type of TPMS.

Generally speaking, a TPMS includes sensor units, a monitoring unit and a display unit. Each sensor unit is installed in a tire attached to a wheel. The monitoring unit is mounted on a vehicle body. And the display unit is installed in a dashboard. A sensor unit, which has an air pressure sensor and a wireless communication device at the minimum, detects an air pressure within the tire, transmitting a signal of the air pressure to the monitoring unit. The monitoring unit monitors the signal and sends a signal indicative of a decrease in the air pressure to the display unit if the air pressure falls below a predetermined value.

A permanent sensor identification, which makes it possible to distinguish the sensor units, is given to each unit during its fabrication. When the sensor unit transmits a signal of tire pressure to the monitoring unit, the sensor identification is carried with the signal. In this way, the monitoring unit is able to determine which air pressure sensor has transmitted the received signal of the tire pressure.

The monitoring unit makes a correlation between a sensor identification (ID) and a location of a tire (including a spare tire) in which a sensor unit having this sensor ID is installed. This correlation is called registration of a sensor ID. The monitoring unit, which registers sensor IDs, is able to determine the location of a tire whose air pressure is decreasing, indicating it on the display unit. In this connection, identification of the location of a tire is divided into a case where all tires, a forward right tire, a forward left tire, a rear right tire, a rear left tire and a spare tire, are distinguished, and the other case where only a rolling tire and a spare tire are distinguished. A TPMS is required to distinguish a rolling tire from a spare tire at the minimum.

Registration of a sensor ID is generally carried out when a tire is attached to a wheel at a maintenance shop and the like, where a dedicated apparatus or process for charging air is employed. Because this type of registration uses the dedicated apparatus, it has been regarded as a burdensome and time consuming method. Furthermore, when a driver replaces a worn tire with a spare tire or make a rotation of tires including a spare tire, the registration made at the maintenance shop will be invalid accordingly.

A method for automatically registering a sensor ID has been proposed recently. For example, there is a method, in which communication antennas are prepared in the vicinity of tires including a spare tire, respectively, and a monitoring unit receives radio waves transmitted by sensor units with the antennas. The monitoring unit determines a sensor unit from which an antenna has received the strongest radio wave. Accordingly, the monitoring unit is able to know a sensor ID of the sensor unit which lies closest relative to the antenna. In this way, it is possible to carry out registration of a sensor ID without manual operation.

However, because a spare tire is stowed near rear tires, the radio waves transmitted by sensor units mounted on the spare tire and the rear tires tend to overlap, interfering with each other. In addition, it may be that a radio wave transmitted by another vehicle traveling in parallel has an adverse effect on radio communication. As a result, the monitoring unit is unable to properly recognize a reception level of radio wave received by each antenna, possibly leading to an erroneous registration of a sensor ID.

There is another method for automatically registering a sensor ID, which utilizes a command indicator of a low frequency electromagnetic wave that is used for transmitting signals for on-off control for a battery of a sensor unit and the like. This type of command indicator is called initiator. According to this method, initiators are positioned near tires including a spare tire, respectively. The monitoring unit transmits a control signal through an initiator which is assigned to a tire, receiving a signal transmitted by a sensor unit in response to this control signal. Because a sensor ID of the responded sensor unit is carried in the received signal, the monitoring unit is able to know the sensor ID of the sensor unit which is located closest to the initiator, thereby registering the sensor ID.

However, this method has the similar problem attributed to the fact that the spare tire is stowed near rear tires. For example, a control signal transmitted by an initiator positioned near a rear tire often activates not only a sensor unit for the rear tire but also that for the spare tire. In this connection, the fact that a low frequency wave is typically used for the control signal is also contributes to the anomaly described above. If the anomaly occurs, the monitoring unit simultaneously receives response signals from two sensor units, which results in a trouble that the monitoring unit can not distinguish the rear tire and the spare tire. As a result, the monitoring unit is not able to make correct registration of a sensor ID.

The technical problems described above are all ascribed to the fact that a spare tire is stowed in a vehicle. In order to solve these problems, patent documents 1 and 2 disclose a method for distinguishing a rolling tire from a non-rolling tire (spare tire). The method, which detects a temperature of air within a tire, determines whether or not a tire is rolling based on an increase in the temperature. This method takes into account the phenomenon that an air temperature within a tire mounted on a rolling wheel rises, which is continuously deformed as a result of receiving a force exerted by a vehicle body and a road surface while a vehicle is traveling.

Patent document 1: 2004-82853 (paragraphs 0064-0096 and FIGS. 2-9)

Patent document 2: 2003-154824 (paragraphs 0020-0060 and FIGS. 1-8)

However, the method described above has a drawback that it takes long to know whether or not a tire is rolling based on the temperature increase. The patent document 1 discloses data that a temperature of air within a tire increases by 5 degrees Celsius when a vehicle travels at 100 km/h for 20 minutes. Generally speaking, the faster travels a vehicle, the more will be an increase rate in a temperature of air within a tire. When a vehicle travels at lower speed, for example 50 km/h, it is estimated accordingly that it takes more than 40 minutes to observe a temperature rise of 5 degrees Celsius. Judging from this period of time it is concluded that the method is far from being applicable to a practical use.

### SUMMARY OF THE INVENTION

In view of the problems described above, the present invention seeks for a system and method for monitoring a tire pressure.

It is an aspect of the present invention to provide a system for monitoring a tire pressure, which comprises a sensor unit and a monitoring unit. The sensor unit is mounted on a tire of a vehicle to detect an air pressure in the tire. The monitoring unit is mounted on the vehicle to monitor a signal indicative of the air pressure detected by the sensor unit so as to watch a decrease in the air pressure. The sensor unit comprises an accelerometer so as to detect an acceleration acting on the tire. And the monitoring unit classifies the tire as one of a rolling tire and a spare tire based on a signal indicative of the acceleration transmitted by the sensor unit.

The classification is made in the following manner. If a tire is mounted on a rolling wheel, an acceleration acts on a sensor unit as a result of rotation of the wheel. An accelerometer is installed in the sensor unit so as to detect an acceleration induced by rotation of the wheel. A monitoring unit compares the detected acceleration with a predetermined value, which is, for example, selected to be greater than an acceleration induced by vibration of the vehicle. The monitoring unit determines that the tire is mounted on a rolling wheel if the acceleration is greater than the predetermined value. The monitoring unit otherwise determines that the tire is mounted on a spare wheel.

Because the acceleration is used in the system described above, it is possible to promptly determine rolling or non-rolling of a tire if the vehicle starts traveling to reach a predetermined speed.

It is another aspect of the present invention to provide a system for monitoring a tire pressure, which comprises a sensor unit and a monitoring unit. The sensor unit is mounted on a tire of a vehicle to detect an air pressure in the tire. The monitoring unit is mounted on the vehicle to monitor a signal indicative of the air pressure detected by the sensor unit so as to watch a decrease in the air pressure. The sensor unit comprises an accelerometer so as to detect an acceleration acting on the tire. When the vehicle travels at not less than a predetermined speed, the monitoring unit determines whether or not the tire is rolling based on a signal of the acceleration and a signal of a sensor identification which are transmitted by the sensor unit. And the monitoring unit comprises a memory module which stores a correlation between the sensor identification and the tire.

If the predetermined speed is selected in such a manner that an acceleration induced by rotation of the wheel traveling at this speed is sufficiently greater than an acceleration induced by vibration of the vehicle, it is possible to reliably determine rolling or non-rolling of a wheel. The monitoring unit registers a correlation between a sensor ID and a tire, which has been classified as a rolling or spare tire.

Because the monitoring module registers a sensor ID in the memory module, the monitoring module is able to determine if a tire experiencing an air decrease is mounted on a rolling or spare wheel by making access to the memory module, even if the vehicle travels at a lower speed or comes to a stop.

It is still another aspect of the present invention to provide a system for monitoring a tire pressure, in which the monitoring unit further comprises an alarm module. The alarm module raises an alarm with information on the tire classified as one of a rolling tire and a spare tire, when the monitoring unit detects a decrease in the air pressure in the tire.

When the monitoring unit detects the decrease in the air pressure in the tire, the monitoring unit is able to promptly and reliably determine whether the tire is mounted on a rolling or spare tire. In order to make this determination, the monitoring unit compares the acceleration with the predetermined value, or makes access to the memory module according to the sensor ID. The monitoring module delivers an alarm including information which tells whether the decrease in the air pressure occurs in a rolling or spare tire.

It is yet another aspect of the present invention to provide a method for monitoring a tire pressure with a system which comprises a sensor unit that is mounted on a tire of a vehicle and a monitoring unit that is mounted on the vehicle. The method comprises the following steps: detecting an air pressure in the tire and an acceleration acting on the tire; monitoring a signal indicative of the air pressure detected by the sensor unit so as to watch a decrease in the air pressure; receiving a signal of the acceleration and a signal of a sensor identification assigned to the sensor unit which are transmitted by the sensor unit; when the vehicle travels at not less than a predetermined speed, determining whether or not the tire is rolling based on the signal of the acceleration and the signal of the sensor identification, and registering a correlation between the sensor identification and the tire; and when a decrease in the air pressure in the tire is detected, classifying the tire as one of a rolling tire and a spare tire, and raising an alarm.

The predetermined speed is selected in such a manner that an acceleration induced by rotation of a wheel at the location of a sensor unit is sufficiently greater than an acceleration induced by vibration of a vehicle. In this way, the method enables the monitoring unit to register a sensor ID with the memory module without erroneously classifying a tire as a rolling or spare tire.

Furthermore, a driver is able to know simultaneously to which type of tire, a rolling or spare tire, the tire belongs, which has experienced a decrease in tire pressure.

### BRIEF DESCRIPTION OF THE DRAWINGS

FIG. 1 is a schematic diagram illustrating a system setup for a vehicle on which a system for monitoring a tire pressure according to the present invention is mounted.

FIG. 2 is a block diagram showing structure of a sensor unit according to the present invention.

FIG. 3 is a schematic diagram illustrating a configuration of data which a sensor unit transmits.

FIG. 4 is a functional block diagram illustrating a monitoring unit according to the present invention.

FIG. 5 is a flow chart showing a flow executed by a monitoring unit according to the present invention.

FIG. 6 is a graph showing the relationship between rotational acceleration generated by rotation of a wheel and speed of a vehicle.

FIG. 7 is a schematic diagram illustrating the configuration of a module for storing registered sensor ID.

FIG. 8 is a flow chart showing steps carried out by a module for determining decrease in tire pressure and a module for generating alarm.

### DESCRIPTION OF THE PREFERRED EMBODIMENTS

An embodiment of the present invention is now described with reference to the accompanying drawings.

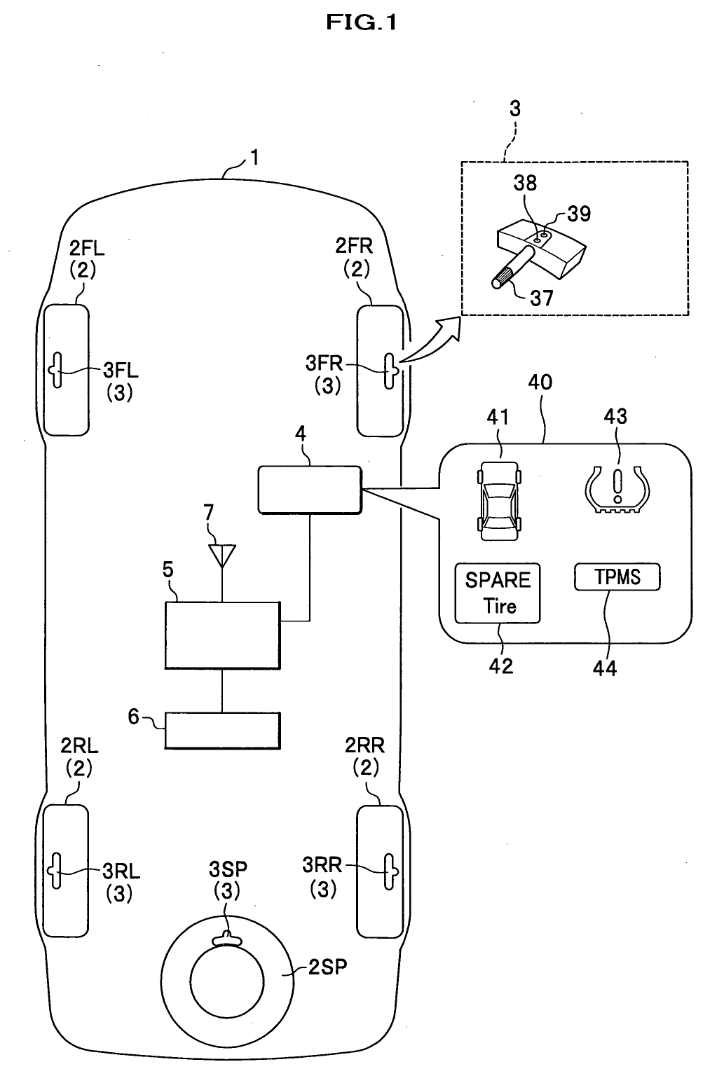

As shown in FIG. 1, a vehicle 1, whose forward portion is shown at the top of FIG. 1, has four rolling wheels, namely a forward right wheel 2FR, a forward left wheel 2FL, a rear right wheel 2RR and a rear left wheel 2RL. In addition, the vehicle 1 has a spare wheel 2SP mounted on its rear portion. Sensor units 3FR, 3FL, 3RR, 3RL and 3SP are installed in tires attached to the wheels 2FR, 2FL, 2RR, 2RL and 2SP, respectively.

In description hereinafter, rolling wheels 2 is meant to represent all of the wheels 2FR, 2FL, 2RR and 2RL, so that they are distinguished from the spare wheel 2SP. In contrast, sensor units 3 is meant to represent all sensor units 3FR, 3FL, 3RR, 3RL and 3SP, not distinguishing the sensor unit 3SP installed in the tire attached to the spare wheel 2SP from other sensor units.

In the upper right portion of FIG. 1, a sensor unit 3 is schematically illustrated. A lower surface of the sensor unit 3, which faces downward in FIG. 1, is adapted to be curved so that it fits to a surface of a rim. In an upper surface of the sensor unit 3, which faces upward in FIG. 1, an air hole 38 and a sensor hole 39 are made. The air hole 38 is directly communicated with a tire valve 37. On the other hand, the sensor hole 39 is communicated with a place where an air pressure sensor and an accelerometer (both not shown) are installed. In this way, the sensor unit 3 detects an air pressure within a tire and acceleration, outwardly transmitting signals indicative of the detected data through a transmitter and antenna (both not shown).

A monitoring unit 5, which is mounted on the vehicle 1, receives wireless signals with an antenna 7, which are transmitted by a sensor unit 3 installed in a tire attached to each wheel, thereby acquiring its tire pressure and acceleration. The monitoring unit 5 inspects if there is a decrease in tire pressure by making a comparison between the acquired tire pressure and a predetermined value. If the monitoring unit 5 detects a decrease, the monitoring unit 5 displays it on an indicator 4 disposed in a display unit positioned in front of a driver's seat.

The monitoring unit 5, to which a speed sensor 6 is electrically connected, receives a signal indicative of a vehicle speed. For example, it may be possible to incorporate a rotational speed of a drive shaft, which lies in a backward stage of a transmission, as the vehicle speed. Furthermore, it may be possible to utilize a sensor provided for each wheel so as to implement an Antilock Brake System (ABS) instead of the speed sensor 6. Though an average speed is typically adopted for the vehicle speed in this case, it may be alternatively possible to select a different type of speed other than the average speed.

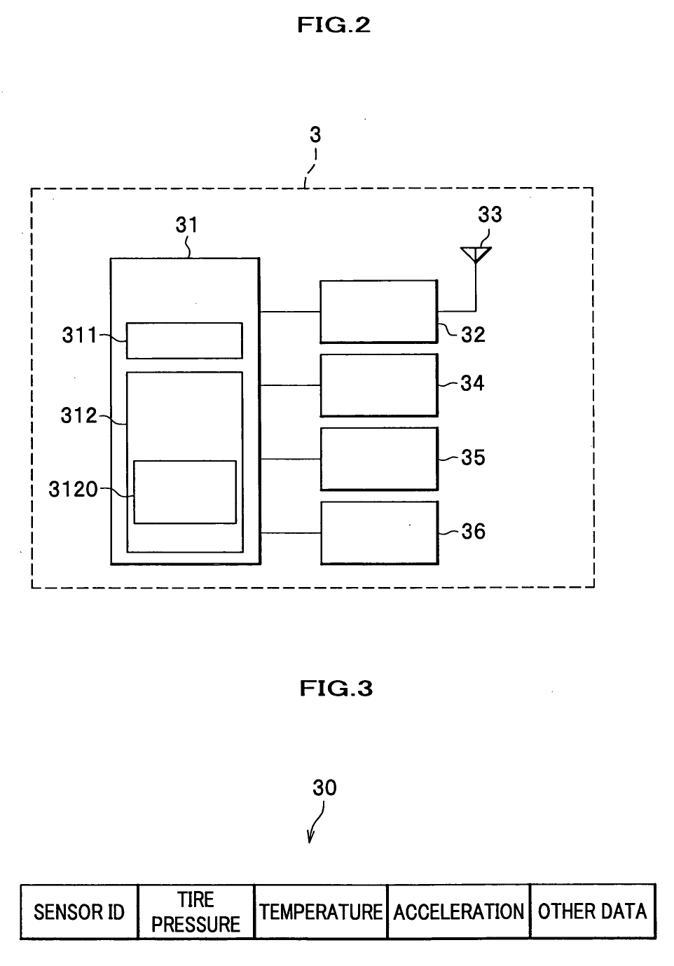

Description is given of structure and function of the sensor unit 3 and the monitoring unit 5 with reference to FIGS. 2-4.

As shown in FIG. 2, the sensor unit 3 includes a micro processor 31, to which a transmitter 32 with an antenna 33 in addition to a pressure sensor 34, a temperature sensor 35 and an accelerometer 36 are electrically connected. The micro processor 31 has an arithmetic processor 311 and a memory 312. The memory 312, which typically includes a Random Access Memory (RAM) and Read Only Memory (ROM), has a sensor ID memory 3120 which occupies a portion of this ROM. The sensor ID memory 3120 stores a sensor ID so that a sensor unit 3 is given its individual identification.

The micro processor 31 has a timer (not shown) so as to collect data such as a tire pressure detected by the pressure sensor 34, temperature detected by the temperature sensor 35 and acceleration of a tire detected by the accelerometer 36, at regular intervals, each 10 minutes, for example. The micro processor 31 assigns a sensor ID, which it reads out from the sensor ID memory 3120, to these air pressure, temperature and acceleration, generating a data unit 30. The micro processor 31 transmits the data unit 30 outside the sensor unit 3 with the transmitter 32 and antenna 33.

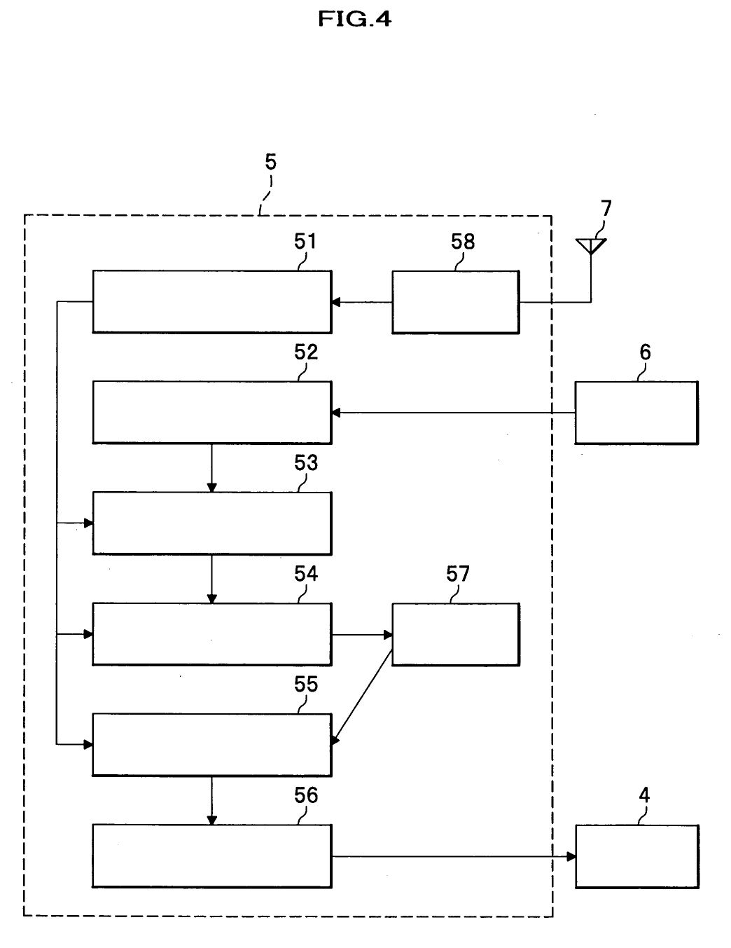

As shown in FIG. 4, the monitoring unit 5 includes a module 51 for receiving signal of sensor unit, a module 52 for entering signal of speed sensor, a module 53 for determining wheel movement, a module 54 for registering sensor ID, a module 55 for determining decrease in tire pressure, a module 56 for generating alarm, a module 57 for storing registered sensor ID and a receiver 58. In the monitoring unit 5, these modules except for the receiver 58 are configured in a computer (not shown) having a processor and memory. More specifically speaking, the memory provides an area for the module 57, and the processor executes computer programs stored in the memory so as to implement functionalities associated with the modules 51, 52, 53, 54, 55 and 56.

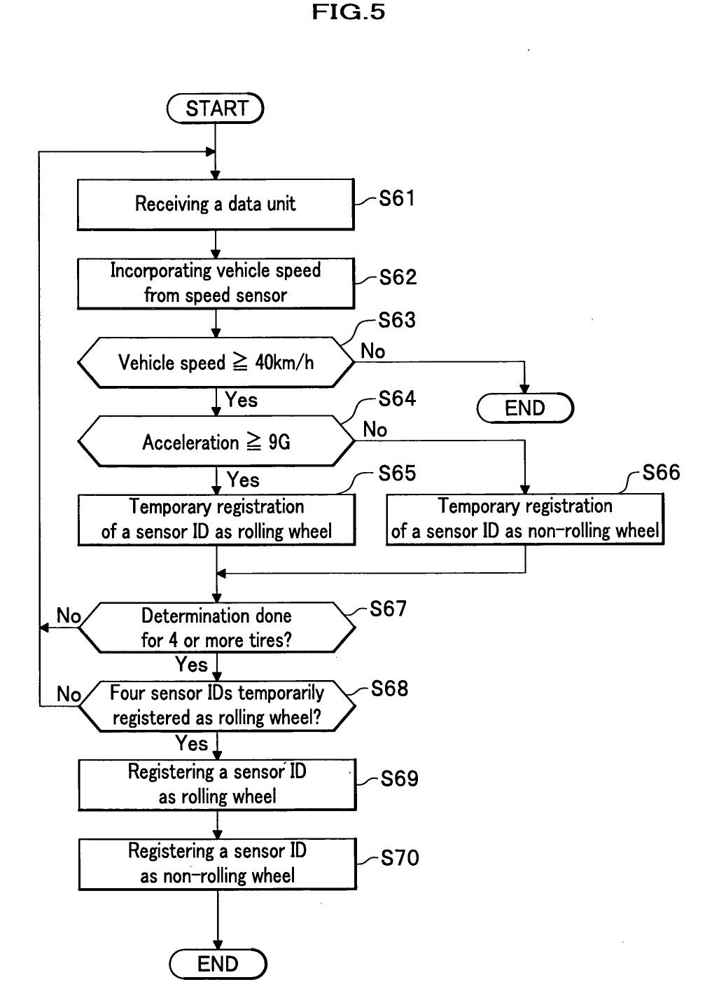

Description is given of operation for each of the modules 51-56 with reference to FIGS. 5-8 in addition to FIG. 4.

As shown in FIG. 5, the module 51 receives a signal indicative of a data unit 30 transmitted by a sensor unit 3 with the receiver 58 and the antenna 7 (step S61). As shown in FIG. 3, the data unit 30 includes a sensor ID identifying which sensor unit 3 has detected the data unit 30.

The module 52 incorporates a signal indicative of vehicle speed from the speed sensor 6 (step S62).

The module 53 determines whether or not the tire to which the sensor unit 3 is attached is rolling based on an acceleration included in the data unit 30 received by the module 51 and a vehicle speed incorporated by the module 52.

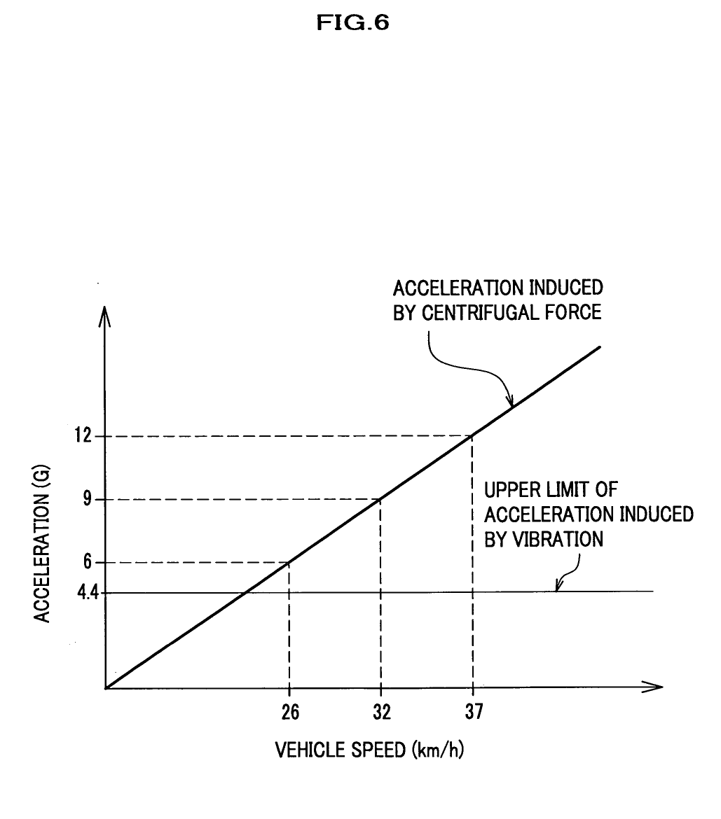

Generally speaking, when a wheel rotates, it imposes a centrifugal force on a sensor unit 3 attached to a tire. As a result the sensor unit 3 detects an acceleration. A rotational speed of a wheel, namely a speed of the vehicle 1 (vehicle speed) and acceleration induced by the centrifugal force relate as shown in FIG. 6. For example, FIG. 6 shows that when a vehicle speed is 32 km/h, an acceleration of 9 G acts on the sensor unit 3. In this connection, it is known that an acceleration induced by vibration of the vehicle 1 while running does not exceed an upper limit of 4.4 G, approximately.

Accordingly, when the sensor unit 3 detects an acceleration of not less than a predetermined value, 9 G for example, it is possible to determine that a tire, to which the sensor unit 3 is attached, is rolling. It may be alternatively possible to select a smaller value than 9 G as long as it is greater than 4.4 G. The value of 9 G is selected as an example, taking into account a maximum error of 3 G for an accelerometer 36. The acceleration 9 G also includes a margin. Because the sensor unit 3 accordingly keeps the margin of 1.6 G, it is possible to reliably distinguish an acceleration induced by rotation of a wheel from that by vibration.

As shown in FIG. 5, the unit 53 determines whether or not the vehicle speed received in step S62 reaches a predetermined speed, for example 40 km/h (step S63). This step is carried out so as to provide more reliable determination of rolling or non-rolling for a tire. As shown in FIG. 6, if a vehicle speed is equal to or more than 40 km/h, an acceleration including the error will not fall to 9 G. Accordingly, if the vehicle speed is equal to or more than 40 km/h (Yes in step S63), the unit 53 conducts determination of rolling/non-rolling for a tire. Otherwise (No in step S63), the unit 53 terminates processing without carrying out the determination.

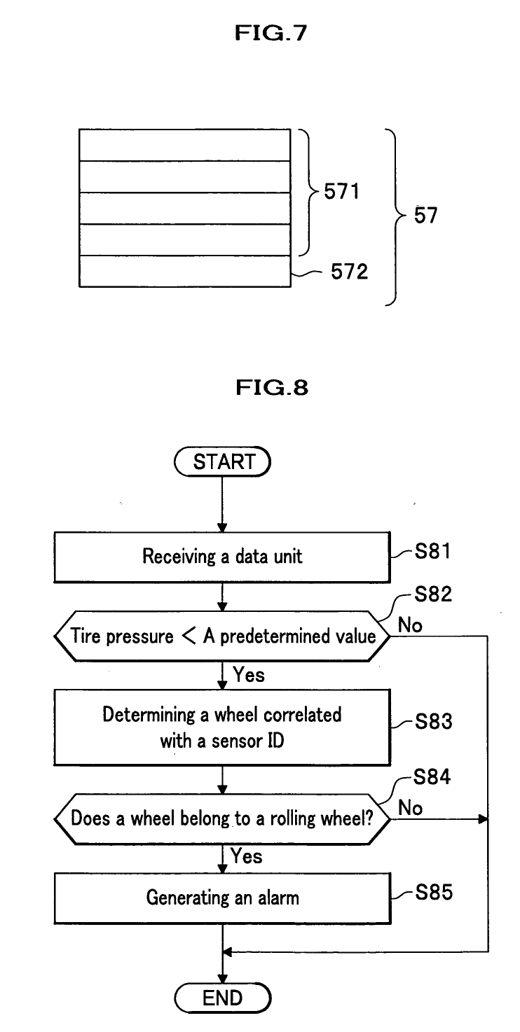

When the vehicle speed is equal to or more than 40 km/h (Yes in step S63), the unit 53 determines whether or not an acceleration, one of the signals received in step S61, is equal to or more than 9 G (step S64). If the acceleration is equal to or more than 9 G (Yes in step S64), the module 54 determines that the tire is rolling and temporarily registers a sensor ID correlated with the sensor unit 3 as a rolling wheel 2 (step S65). Making a temporary registration of a received sensor ID as a rolling wheel 2 is meant to store the sensor ID into a memory area 571 for rolling wheel provided in the module 57, as shown in FIG. 7.

When the acceleration is less than 9 G (No in step S64), the module 54 determines that the tire is not rolling, registering temporarily the sensor ID as a non-rolling wheel (step S66). Making a temporary registration of a received sensor ID as a non-rolling wheel is meant to store the sensor ID into a memory area 572 for spare wheel provided in the module 57, as shown in FIG. 7.

Next, the module 54 checks whether or not determination of rolling/non-rolling wheel has been carried out based on the data unit 30 for not less than 4 out of 5 tires including the spare wheel 2SP (step S67). If the determination has been done for not less than 4 tires (Yes in step S67), the module 54 checks if four sensor IDs have been registered as rolling wheels 2 (step S68). If the four sensor IDs have been temporarily registered as the rolling wheels 2 (Yes in step S68), the module 54 registers not only them as the rolling wheels 2 (step S69), but also a sensor ID, which has been temporarily registered as a non-rolling wheel, as a spare wheel 2SP (step S70).

If the module 54 has not checked the data unit 30 for not less than 4 wheels (No in step S67), or the four sensor IDs have not been temporarily registered as the rolling wheels 2 in step S68 (No in step S68), the module 54 returns to step S61, carrying out step S61 and subsequent steps for another data unit 30, which has not yet undergone processing.

Registration of a sensor ID is meant to store a sensor ID into one of the memory area 571 for rolling wheel and the memory area 572 for spare wheel provided in the module 57. As registration is first carried out in steps for making temporary registration (steps S65 and S66) in the present embodiment, the registration of a sensor ID in steps S69 and S70 is actually meant to confirm completion of temporary registration and to notify that information in the module 57 has been available for steps shown in FIG. 8 to be described later.

Logic applied to steps S67 and S68 may create a case where a sensor ID is not registered in the memory area 572 for spare wheel. However, even in this case, a sensor ID of a sensor unit 3 attached to a tire, which is classified as a rolling wheel 2 by the steps shown in FIG. 5, is registered in the memory area 571 for rolling wheel. When a TPMS gives an alarm only for a tire which is mounted on a rolling wheel 2, no problems will occur. Furthermore, when the TPMS separately gives an alarm for a rolling wheel 2 and a spare wheel 2SP, no problems will occur, either. The reason for this is explained as follows. When a sensor ID is not registered in the memory area 571 and the memory area 572 is blank (no registration), it is possible to conclude that a data unit 30 given this sensor ID has been transmitted by a sensor unit 3, which is attached to a spare wheel 2SP.

As described above, after the completion of registration of a sensor ID, the monitoring unit 5 checks a decrease in a tire pressure. If the monitoring unit 5 detects a decrease, it generates an alarm.

As shown in FIG. 8, the module 55 for determining decrease in tire pressure (see FIG. 4) receives a data unit 30 (step S81), which is transmitted by a sensor unit 3 attached to each tire. As shown in FIG. 3, the data unit 30 includes a tire pressure and a sensor ID. The module 55 determines whether or not the received tire pressure has fallen below a predetermined value (step S82). If the tire pressure has not fallen below the predetermined value (No in step S82), the process is automatically terminated.

In contrast, if the tire pressure has fallen below the predetermined value (Yes in step S82), the module 55 makes access to the module 57 so as to identify a wheel with which the received sensor ID is correlated (step S83). If the wheel is classified as a rolling wheel 2 (Yes in step S84), the module 56 sends the indicator 4 an alarm calling attention to a decrease in tire pressure (step S85). If the wheel is not classified as a rolling wheel 2 (No in step S84), the module 56 terminates steps without sending an alarm.

Though the module 56 does not give an alarm for the spare wheel 2SP in the flow shown in FIG. 8, it may be alternatively possible that the module 56 gives an alarm for the spare wheel 2SP. In this case, step S84 can be eliminated. It may be necessary instead that an alarm generated in step S85 should be configured so as to tell to which category a wheel experiencing a decrease in tire pressure belongs, a rolling wheel 2 or a spare wheel 2SP.

In FIG. 1 an example of display 40 is shown, which is provided by the indicator 4 so as to give an alarm for a decrease in tire pressure. It is assumed that the example of display 40 includes display of an alarm for a spare wheel 2SP. When an alarm is given for a rolling wheel 2, an icon 41 symbolizing vehicle and an icon 43 symbolizing an unusual tire are highlighted. In contrast, when an alarm is given for the spare wheel 2SP, an icon 42 symbolizing spare tire and the icon 43 are highlighted. An icon 44, which symbolizes an unusual TPMS system, is highlighted when an anomaly occurs in the TPMS system. If an alarm is not required for the spare wheel 2SP, it may be possible to eliminate the icons 41 and 42.

The embodiment described above, in which the accelerometer 36 in the sensor unit 3 detects an acceleration induced by rotation of a wheel, determines whether or not the wheel is rolling. In this way, it is possible to determine whether or not a tire is rolling by assessing acceleration, which is detected while the vehicle 1 is traveling at not less than a predetermined speed (40 km/h, for example), based on a threshold of predetermined acceleration, 9 G for example, which is greater than an upper limit of acceleration (4.4 G) induced by vibration of a vehicle.

Next, description is given of a modification for the embodiment described above.

It may be possible to carry out comparison of acceleration with a predetermined value (9 G for example) in a sensor unit 3 instead of a monitoring unit 5. In this case, a micro processor 31 of the sensor unit 3 makes the comparison, and the sensor unit 3 transmits only the result to the monitoring unit 5. More specifically speaking, the sensor unit 3 transmits “true” or “false” signal, namely “1” or “0” signal. Though this requires modification for some of the steps in the monitoring unit 5, the same method is basically inherited.

Though the embodiment described above does not have a function of displaying the location of a tire attached to a rolling wheel 2, which experiences a decrease in tire pressure, it may be possible to implement this function by adding a conventional initiator, for example. More specifically speaking, an initiator, which is able to appoint a sensor unit 3 to respond, is placed near each rolling wheel 2. In this way, a monitoring unit 5 acquires the function described above. As described in “BACKGROUND OF THE INVENTION”, addition of initiators alone does not enable distinguishing rear tires from a spare tire. If information stored in a module 57 for storing registered sensor ID according to the present invention is introduced in addition to the initiators, it is possible not only to distinguish the rear tires from the spare tire, but also to correlate a sensor ID with a tire attached to each rolling wheel 2. As a result, it is possible to give the location of a rolling tire in displaying an alarm calling attention to a decrease in tire pressure.

It should be noted that the present invention is applicable to both types of spare tires such as an emergency tire, a tempa spare tire, for example, and a normal tire.

Foreign priority document, JP 2004-198129 filed on Jul. 5, 2004, is hereby incorporated by reference.

1. A system for monitoring a tire pressure comprising:
a sensor unit which is mounted on a tire of a vehicle to detect an air pressure in the tire; and
a monitoring unit which is mounted on the vehicle to monitor a signal indicative of the air pressure detected by the sensor unit so as to watch for a decrease in the air pressure,
wherein the sensor unit comprises an accelerometer so as to detect an acceleration acting on the tire, and
wherein the monitoring unit classifies the tire as one of a rolling tire and a spare tire based on a signal indicative of the acceleration transmitted by the sensor unit.

2. A system for monitoring a tire pressure according to claim 1, wherein the monitoring unit further comprises an alarm module, and wherein when the monitoring unit detects a decrease in the air pressure in the tire, the monitoring unit raises an alarm with information on the tire classified as one of a rolling tire and a spare tire.

3. A system for monitoring a tire pressure comprising:
a sensor unit which is mounted on each tire of a vehicle to detect an air pressure in the tire; and
a monitoring unit which is mounted on the vehicle to monitor a signal from each sensor unit indicative of the air pressure detected by the respective sensor unit so as to watch for a decrease in the air pressure in any of the tires,
wherein each sensor unit comprises an accelerometer so as to detect an acceleration acting on the respective tire,
wherein when the vehicle travels at not less than a predetermined speed, the monitoring unit determines whether or not each tire is rolling based on a signal of the acceleration and a signal of a sensor identification which are transmitted by each sensor unit, and
wherein the monitoring unit comprises a memory module which stores a correlation between the sensor identification and the respective tire.

4. A system for monitoring a tire pressure according to claim 3, wherein the monitoring unit further comprises an alarm module which raises an alarm when the monitoring unit detects a decrease in the air pressure in a tire, the alarm comprising information on the tire classified as one of a rolling tire and a spare tire.

5. A method for monitoring a tire pressure with a system which comprises a sensor unit that is mounted on a tire of a vehicle and a monitoring unit that is mounted on the vehicle, the method comprising the steps of;
detecting an air pressure in the tire and an acceleration acting on the tire;
monitoring a signal indicative of the air pressure detected by the sensor unit so as to watch for a decrease in the air pressure;
receiving a signal corresponding to the acceleration and a signal corresponding to a sensor identification assigned to the sensor unit which are transmitted by the sensor unit;
when the vehicle travels at not less than a predetermined speed, determining whether or not the tire is rolling based on the signal of the acceleration and the signal of the sensor identification, and registering a correlation between the sensor identification and the tire; and
when the decrease in the air pressure in the tire is detected, classifying the tire as one of a rolling tire and a spare tire, and raising an alarm.

6. The system for monitoring a tire pressure of claim 1, wherein a sensor unit is mounted on each tire of the vehicle, including all axle-mounted tires and spares.

7. The method for monitoring a tire pressure of claim 5, wherein a sensor unit is mounted on each tire of the vehicle, including all axle-mounted tires and spares.
